(19) United States
(12) Patent Application Publication
(10) Pub. No.: US 2019/0278365 A1
(43) Pub. Date: Sep. 12, 2019

(54) CONTROL APPARATUS AND PROCESS

(71) Applicant: SKOOGMUSIC LTD, Edinburgh Lothian (GB)

(72) Inventors: David John SKULINA, Edinburgh (GB); Benjaman Warren SCHÖGLER, Edinburgh (GB); Keith NAGLE, Edinburgh (GB); James CALLAGHAN, Edinburgh (GB)

(21) Appl. No.: 16/291,627

(22) Filed: Mar. 4, 2019

(30) Foreign Application Priority Data
Mar. 6, 2018 (GB) 1803600.4

(51) Int. Cl. G06F 3/00; G06K 9/00; G06F 3/01

(52) U.S. Cl. CPC G06F 3/005; G06F 3/013; G06K 9/00302

(57) ABSTRACT

The present invention relates to a control arrangement 10. The control arrangement 10 comprises computer apparatus 12, 18 storing a control function which controls computer software in dependence on control data received by the control function from a manually or voice operated user interface. The control arrangement also comprises a camera 14 providing image data to the computer apparatus 12, 18 in dependence on at least one image acquired by the camera. The computer apparatus 12, 18 recognises a facial expression in image data received from the camera 14 when the camera acquires an image of a face. The computer apparatus 12, 18 also operates the control function in dependence on the recognised facial expression, whereby the computer software is controlled by the facial expression instead of by operation of the manually or voice operated user interface.

### FIELD OF THE INVENTION

The present invention relates to control arrangements and processes for controlling computer software.

### BACKGROUND ART

It is known to make access to computer apparatus dependant on facial recognition whereby access is gained by authorised persons only. Recognition of facial expressions by way of computer apparatus is also known. In a known application of facial expression recognition, an App running on computer apparatus performs facial expression recognition on images of a face of a person acquired by the computer apparatus. The App also provides for display of a fanciful representation of a face on a display of the computer apparatus. Furthermore, the App provides for control of the facial expressions of the representation in dependence on the facial expression recognition whereby the facial expressions of the representation mimic the facial expressions of the person whose image is being acquired by the computer apparatus.

Mindful of the above known approaches involving facial recognition and facial expression recognition, the present inventors have recognised an opportunity to provide for ease of use of the like of computer apparatus by persons with disabilities.

It is therefore an object for the present invention to provide a control arrangement for controlling computer software in dependence on at least one image of a user and more specifically an image of a face of a user. It is a further object for the present invention to provide a control process for controlling computer software in dependence on at least one image of a user and more specifically an image of a face of a user.

### STATEMENT OF INVENTION

According to a first aspect of the present invention there is provided a control arrangement comprising:
computer apparatus storing a control function controlling computer software in dependence on control data received by the control function from a manually or voice operated user interface; and
a camera providing image data to the computer apparatus in dependence on at least one image acquired by the camera,
the computer apparatus: recognising a facial expression in image data received from the camera when the camera acquires an image of a face; and operating the control function in dependence on the recognised facial expression, whereby the computer software is controlled by the facial expression instead of by operation of the manually or voice operated user interface.

The control arrangement comprises computer apparatus storing a control function. The control function controls computer software in dependence on control data received by the control function from a manually or voice operated user interface. For example, the control function opens or closes a software application in dependence on a command provided by way operation of a keyboard or mouse of the computer apparatus. The control arrangement also comprises a camera providing image data to the computer apparatus in dependence on at least one image acquired by the camera. The computer apparatus recognises a facial expression, such as movement of eyes from left to right, in image data received from the camera when the camera acquires an image of a face, such as the face of the user of the computer apparatus.

The computer apparatus also operates the control function in dependence on the recognised facial expression whereby the computer software is controlled by the facial expression instead of by operation of the manually or voice operated user interface. The control arrangement may thus provide for control of the computer software by a person who is unable to exert control over the computer software manually or by speaking commands into a microphone of the computer apparatus.

For example, a disabled person who is unable to operate a keyboard or mouse of the computer apparatus may control the computer software by making a predetermined facial expression. Alternatively, a person who is able to operate a keyboard or mouse of the computer apparatus may have his or her hands freed for other use.

The computer apparatus may store plural control functions with each of the plural control functions controlling computer software in a different way in dependence on respective control data received by the control function from a manually or voice operated user interface. Furthermore, the computer apparatus may recognise one of plural facial expressions in image data received from the camera when the camera acquires an image of a face. The computer apparatus may map each of the plural facial expressions to a respective one of the plural control functions. The computer apparatus may therefore operate the control function to which the recognised facial expression maps, whereby the computer software is controlled by the recognised facial expression.

The computer apparatus is operative to recognise a facial expression in image data received from the camera. The computer apparatus may be operative to recognise at least one part of an image of a face, such as the pupils or an eyelid, and to determine at least one of: a location and more specifically movement of the at least one part of the image relative to another part of the image; and movement of the at least one part of the image relative to itself. For example, the computer apparatus may be operative to recognise that one of the pupils is at the left of the eye socket with reference to another part of the face, such as the nose. By way of another example, the computer apparatus may be operative to recognise that one of the pupils has moved from the right of the eye socket to the left of the eye socket. Facial expression recognition may further comprise recognition of movement or position of the face itself, such as a nod or a turn of the head to left or right, or a disposition of a part of the face, such as a closed eyelid.

At least one control function may be operated in dependence on both of: recognition of a facial expression involving location and perhaps movement of one part of the image of the face relative to another part of the image of the face; and recognition involving determining a location of a head comprising the face in an image. More specifically, determining a location of a head comprising the face in an image may comprise determining an orientation of the head. The orientation may be determined in three dimensions. Operation of the control function in dependence on both of these inputs may, for example, result in movement of a cursor on a display of the computer apparatus in dependence on the orientation determination with the facial expression recognition performing the equivalent of left or right mouse clicks.

The computer apparatus may be operative to determine a position of at least a part of the face in relation to a display of the computer apparatus. For example, the computer apparatus may be operative to determine that eye gaze is directed to a particular location on the display. Control of the computer software may be in dependence on the determined position relative to the display. For example, the user may direct his gaze to a ‘play’ button in a graphical user interface on the display whereby the ‘play’ button may be pressed in dependence on facial expression recognition instead of positioning a cursor over the ‘play’ button and clicking a mouse. The computer apparatus may be configured to provide for position determination relative to the display, such as during a calibration process which might, for example, be carried out before the computer software is used. The calibration process may comprise: acquiring an image of a user's face when in a reference position, such as in respect of predetermined distance between the face and the display, predetermined orientation of the head and hence face in relation to the display, and position of the head and hence face in a plane parallel to a plane defined by the display. During the calibration process, the computer apparatus may display a graphic on the display, such as an oval shape, to guide the user as to where to locate his face relative to the display. Alternatively or in addition, the computer apparatus may display an array of graphical elements, such as dots, on the display and prompt the user to direct his or her gaze at each of the graphical elements in turn while acquiring an image of the user's face.

Control of the computer software may be in dependence on recognition of more complex facial expression recognition. For example, facial expression recognition may comprise recognising that a user's gaze is directed to a particular location on the display and also that the user's gaze is held at that particular location for more than a predetermined length of time, such as more than three seconds. By way of further example, facial expression recognition may comprise recognising that a user's gaze is directed to a particular location on the display and then recognising that the user has blinked when holding his or her gaze at that particular location. The risk of accidental control of the computer software may thus be reduced. The computer apparatus may therefore receive plural temporally spaced apart images from the camera with the facial expression recognition being carried on in dependence on the plural temporally spaced apart images.

Facial expression recognition may be performed by known facial recognition software, such as the Apple® ARKit development platform which comprises ARFaceAnchor objects.

As mentioned above, the control function controls computer software in dependence on control data received by the control function from a manually or voice operated user interface. The control function may therefore be a known control function that may, for example, be provided perhaps as a matter of course in a library of control functions. The computer apparatus may be configured to place a call to the control function to thereby invoke the control function in dependence on recognition of the facial expression. The computer apparatus may be configured to place the call by way of software of known form and function. The control function may thus be invoked by recognition of the facial expression instead of by customary voice input or more usually by operation of a manually operable user interface.

The computer software may be one of application software and system software. Where the computer software is application software, the control function may control at least one of the like of: starting or stopping the application software; saving or uploading data relating to the application software; and configuring the application software in respect of operation of the application software. Where the computer software is system software, such as the operating system, the control function may control at least one of the like of: powering down the computer apparatus; installing or deleting application software; loading and executing application software; configuring a user interface such as a display; and controlling a peripheral device.

The camera may be comprised in and more specifically may be integral to the computer apparatus. The camera may be of known form and function. The computer apparatus may comprise first computer apparatus. The first computer apparatus may be personal computer apparatus and more specifically handheld computer apparatus, such as a tablet computer or a smartphone. The first computer apparatus may recognise the facial expression in image data received from the camera when the camera acquires an image of a face. In addition, the control function may be stored in the first computer apparatus and the first computer apparatus may control the control function in dependence on the recognised facial expression. Alternatively, the computer apparatus may comprise second computer apparatus with the control function being stored in the second computer apparatus and the second computer apparatus controlling the control function in dependence on recognition of the facial expression by the first computer apparatus.

The computer software may run on and may more specifically be stored in the first computer apparatus. Alternatively, the computer software may run on and may more specifically be stored in the second computer apparatus. Computer software running on the second computer apparatus may be controlled in dependence on facial expression recognition being performed on the first computer apparatus and perhaps also operation of the control function on the first computer apparatus. Otherwise, the control function may be operated on the second computer apparatus.

As mentioned above, the first computer apparatus may be personal computer apparatus. The second computer apparatus may be in data communication with the first computer apparatus whereby control may be exerted by the first computer apparatus over computer software running on the second computer apparatus. The second computer apparatus may be remote from the first computer apparatus and may comprise computer apparatus accessible, for example, by way of the Internet. Alternatively, the second computer apparatus may be local to the first computer apparatus. The second computer apparatus may be the like of a home entertainment system, a home automation system, a game system, such as a video game console, or a sound producing electronic device, such as a musical instrument. Such computer apparatus may comprise a computer system and more specifically an embedded computer system. The control apparatus may therefore be used to participate in a video game, control heating and lighting in a home, control an entertainment system or play an electronic musical instrument.

The control function may be configured to control a musical or audio device. The control function may, for example, be a MIDI message. The computer software may be operative in dependence on at least one such MIDI message. The computer software may generate sound data for controlling a sound producing electronic device. The control arrangement may comprise the sound producing electronic device. Control by way of the control function may be in respect of sound generation and more specifically proportional control of sound generation.

Further embodiments of the first aspect of the present invention may comprise one or more features of any other aspect of the present invention.

According to a second aspect of the present invention there is provided a control process comprising:
storing a control function in computer apparatus, the control function controlling computer software in dependence on control data received by the control function from a manually or voice operated user interface;
providing image data to the computer apparatus from a camera in dependence on at least one image acquired by the camera;
recognising a facial expression in image data received from the camera when the camera acquires an image of a face; and
operating the control function in dependence on the recognised facial expression, whereby the computer software is controlled by the facial expression instead of by operation of the manually or voice operated user interface.

Embodiments of the second aspect of the present invention may comprise one or more features of any other aspect of the present invention.

According to a third aspect of the present invention there is provided a computer program comprising program instructions for causing the computer apparatus of the second aspect of the invention to perform at least one of the steps of recognising a facial expression and operating the control function.

The computer program may be one of: embodied on a record medium; embodied in a read only memory; stored in a computer memory; and carried on an electrical carrier signal. Further embodiments of the third aspect of the present invention may comprise one or more features of any other aspect of the present invention.

According to a fourth aspect of the present invention there is provided a control arrangement comprising:
computer apparatus storing: a set of facial expression data corresponding to a facial expression; and a control function performing user control only of user control of and user operation of computer software; and
a camera providing image data to the computer apparatus in dependence on at least one image acquired by the camera,
the computer apparatus: recognising the facial expression in image data received from the camera when the camera acquires an image of a face; and operating the control function in dependence on the recognised facial expression.

The control function performs user control only of user control of and user operation of computer software. The computer software may be one of application software and system software. Where the computer software is application software, user control performed by the control function may comprise at least one of the like of: starting or stopping the application software; saving or uploading data relating to the application software; and configuring the application software in respect of operation of the application software. Where the computer software is application software, operational control performed by the control function may be in respect of activities that are carried out during ordinary operation of the application software and more specifically activities involving interaction of a user with the application software comprising facial expression recognition. Where the computer software is system software, such as the operating system, there is typically more of the system software given over to user control than user operation. User control performed by the control function where the computer software is system software may comprise at least one of the like of: powering down the computer apparatus; installing or deleting application software; and configuring a user interface such as a display.

Further embodiments of the fourth aspect of the present invention may comprise one or more features of any other aspect of the present invention.

The present inventors have appreciated the feature of controlling a musical or audio device by way of the control function to be of wider applicability than hitherto described. Therefore, and according to a fifth aspect of the present invention, there is provided a control arrangement for controlling a sound producing electronic device, the control arrangement comprising:
computer apparatus storing a control function controlling computer software; and
a camera providing image data to the computer apparatus in dependence on at least one image acquired by the camera,
the computer apparatus: recognising a facial expression in image data received from the camera when the camera acquires an image of a face; operating the control function in dependence on the recognised facial expression; and controlling the computer software by way of the control function to generate sound data that provides for proportional control of sound produced by the sound producing electronic device.

The control arrangement for controlling a sound producing electronic device, such as an electronic musical instrument, comprises computer apparatus that stores a control function, such as a MIDI message, controlling computer software. The control arrangement also comprises a camera that provides image data to the computer apparatus in dependence on at least one image acquired by the camera. The computer apparatus recognises a facial expression in image data received from the camera when the camera acquires an image of a face and operates the control function in dependence on the recognised facial expression. The computer apparatus also controls the computer software by way of the control function to generate sound data that provides for proportional control of sound produced by the sound producing electronic device. The control function thus provides for change in sound production that goes beyond a change between sound not being produced and sound being produced whereby an extent of sound produced is variable between not being produced and being produced.

The control arrangement may comprise the sound producing electronic device. As mentioned above, the sound producing electronic device may be an electronic musical instrument or audio device which is operative in dependence on at least one control function as described above and more specifically upon receipt of sound data. At least one control function may provide for at least one of: change in frequency of sound; change in volume of sound and perhaps in respect of volume of one sound component relative to volume of another sound component; change in a characteristic of a filter used in generation of the sound data; and change in tempo.

As mentioned above, the sound data provides for proportional control of sound production. Recognition of the facial expression may therefore comprise recognising a proportional change in facial expression with the sound data being generated in dependence thereon. For example, the computer apparatus may recognise a proportional change between a user's mouth being fully closed and the user's mouth being fully open.

Further embodiments of the fifth aspect of the present invention may comprise one or more features of any other aspect of the present invention.

According to a sixth aspect of the present invention, there is provided a process for controlling a sound producing electronic device, the process comprising:
storing in computer apparatus a control function controlling computer software;
providing image data from a camera to the computer apparatus in dependence on at least one image acquired by the camera;
recognising a facial expression in image data received from the camera when the camera acquires an image of a face;
operating the control function in dependence on the recognised facial expression; and
controlling the computer software by way of the control function to generate sound data that provides for proportional control of sound produced by the sound producing electronic device.

Embodiments of the sixth aspect of the present invention may comprise one or more features of any other aspect of the present invention.

According to a seventh aspect of the present invention there is provided a computer program comprising program instructions for causing the computer apparatus of the sixth aspect of the invention to perform at least one of the steps of recognising a facial expression, operating the control function and controlling the computer software.

The computer program may be one of: embodied on a record medium; embodied in a read only memory; stored in a computer memory; and carried on an electrical carrier signal. Further embodiments of the seventh aspect of the present invention may comprise one or more features of any other aspect of the present invention.

According to a further aspect of the present invention there is provided a control arrangement comprising: computer apparatus storing a control function controlling computer software; and a camera providing image data to the computer apparatus in dependence on at least one image acquired by the camera, the computer apparatus: recognising a facial expression in image data received from the camera when the camera acquires an image of a face; and operating the control function in dependence on the recognised facial expression.

Embodiments of the further aspect of the present invention may comprise one or more features of any previous aspect of the present invention.

According to a yet further aspect of the present invention there is provided a control process comprising: storing a control function in computer apparatus storing a control function, the control function controlling computer software; providing image data from a camera to the computer apparatus in dependence on at least one image acquired by the camera; recognising a facial expression in image data received from the camera when the camera acquires an image of a face; and operating the control function in dependence on the recognised facial expression.

Embodiments of the yet further aspect of the present invention may comprise one or more features of any previous aspect of the present invention.

### BRIEF DESCRIPTION OF DRAWINGS

Further features and advantages of the present invention will become apparent from the following specific description, which is given by way of example only and with reference to the accompanying drawings, in which:

FIG. 1A is a block diagram representation of a control arrangement according to the present invention; and

FIG. 1B is a representation of a display of computer apparatus comprised in the control arrangement of FIG. 1A.

### DESCRIPTION OF EMBODIMENTS

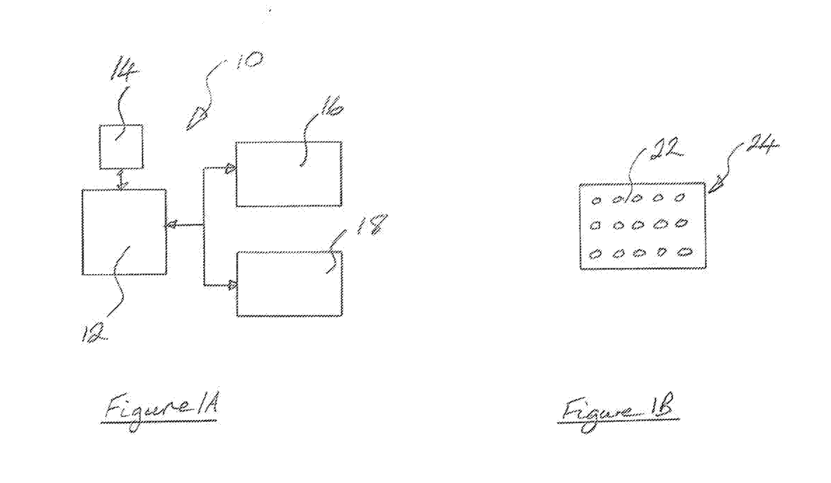

A block diagram representation of a control arrangement 10 according to the present invention is shown in FIG. 1A. The control arrangement 10 comprises a tablet computer 12 (which constitutes first computer apparatus), a camera 14, an electronic musical instrument 16 (which constitutes a sound producing electronic device) and second computing apparatus 18 comprised in a home automation system. The camera 14 is integral to the laptop computer 12.

In a first embodiment, the invention involves use of the tablet computer 12 and the camera 14 alone of the parts shown in FIG. 1A. The tablet computer 12 stores a library of control functions for controlling application software (which constitutes computer software) running on the tablet computer or for controlling the operating system (which also constitutes computer software) of the tablet computer. In accordance with conventional configuration and operation of the tablet computer, the control functions are invoked by manual operation of a hardware interface of the tablet computer, such as the keyboard or a peripherally attached mouse. Where application software is being controlled, the control functions provide for control and configuration of the application software, such as in respect of starting or stopping the application software; saving or uploading data relating to the application software; and configuring the application software in respect of operation of the application software. Where the operating system is being controlled, the control functions provide for control of the operating system such as in respect of the like of powering down the tablet computer, installing or deleting application software, loading and executing application software, configuring a user interface such as a display of the tablet computer and controlling a peripheral device.

The tablet computer 12 also stores plural sets of predetermined facial expression data. In a first approach, the stored sets of facial expression data are formed for a user during a calibration process during which the user is prompted by the tablet computer 12 to make a series of different facial expressions with the camera recording at least one image of the face of the user when making a facial expression. In a second approach, the stored sets of facial expression data are formed by plural users to provide composite sets of facial expression data. The composite sets of facial expression data are formed during a configuration process carried out remotely from the tablet computer, for example, by or on behalf of a vendor of application software operative according to the present invention. The composite sets of facial expression data are conveyed to the tablet computer, for example, by way of the Internet. Each of the plural sets of predetermined facial expression data is mapped by the tablet computer to a respective one of the control functions in the library of control functions. Mapping between sets of predetermined facial expression data and the control functions is by way of an application program of conventional form and function running on the tablet computer. Each set of predetermined facial expression data thus corresponds to a respective control function and hence control of the computer software in a respective fashion.

During use, when the user wishes to control the computer software running on the tablet computer 12 in a particular fashion, the user makes one of the predetermined facial expressions in front of the camera 14 and the camera acquires at least one image of the user's face when the facial expression is made. The at least one image is processed by facial expression recognition software of known form and function to provide active facial expression data and to compare the active facial expression data with the sets of predetermined facial expression data to identify a match between the active facial expression data and one of the sets of predetermined facial expression data. The facial expression recognition software is, for example, built using ARFaceAnchor objects comprised in the Apple® ARKit development platform. Example ARFaceAnchor objects, such as jawOpen and eyeBlinkLeft, are to be found in the blendShapes dictionary. The facial expression recognition software is therefore capable of recognising facial expressions in the form of movement of parts of the facial anatomy, such as the jaw or the eyelid, and also in the form of movement and orientation of the face of the user. The application program running on the tablet computer 12 is operative to invoke the control function that maps to the matching set of predetermined facial expression data whereby the desired form of control of the computer software is exerted.

The application program is operative to provide for facial expression recognition more complex than a simple facial expression. According to a first example, such more complex facial expression recognition comprises recognising that a user's gaze is directed to a particular location on the display of the tablet computer and also that the user's gaze is held at that particular location for more than a predetermined length of time, such as more than three seconds. Where the facial expression recognition is of such form, the application program running on the tablet computer 12 performs a calibration process before proper use begins. The calibration process is described below. According to a second example, in addition to the gaze direction and the gaze holding of the first example, the application program is operative to recognise the orientation of the head comprising the face to thereby move the cursor around the display.

The calibration process comprises displaying the array of dots 22 on the display 24 of the tablet computer 12 as shown in FIG. 1B. Although not shown in FIG. 1B, the display also shows an oval shape. The user is prompted to position his or her face such that the image of the face shown on the display fits inside the oval. The application program is then operative to change the size of the oval shape until the image of the face fills the oval. The position of the face in a plane parallel to the plane of the display is thus known as is the distance between the face and the display. The user is then prompted to direct his or her gaze at each of the dots in the array in turn and an image of the face is acquired when the gaze is directed at each dot. The application program thus has a basis for determining the location on the display where the user is directing his or her gaze during subsequent use.

During subsequent use according to the first example above, the user may direct his or her gaze at a location towards an upper left hand corner of the display where a ‘document open’ button is location and then hold the gaze for at least three seconds. The application program is operative, as described above, to perform facial expression recognition and to invoke the appropriate control function in dependence on a match between the recognised facial expression and one of the sets of predetermined facial expression data. According to the second example above, the orientation of the head of the user provides for movement of the cursor around the display. When the cursor is over the ‘document open’ button, recognition of further facial expressions is used to perform what are otherwise left or right mouse clicks.

In a second embodiment, the invention involves use of the tablet computer 12, the camera 14 and the electronic musical instrument 16 alone of the parts shown in FIG. 1A. The second embodiment is as described above for the first embodiment except as is described below. The tablet computer 12 and the camera 14 are thus operative as described above to perform recognition of facial expressions of the user when the user wishes to control the electronic musical instrument 16. In this embodiment the control functions are MIDI messages resident on the tablet computer 12. A summary of appropriate MIDI messages is to be found here: https://www.midi.org/specifications/otem/table-1-summary-of-midi-message. A match between a recognised facial expression and one of the sets of predetermined facial expression data causes the mapped one of the MIDI messages to be invoked whereby the electronic musical instrument 16 is controlled in the desired fashion.

In a third embodiment, the invention involves use of the tablet computer 12, the camera 14 and the second computing apparatus 18 alone of the parts shown in FIG. 1A. The second computing apparatus 18 is typically embedded in the home automation system. The second embodiment is as described above for the first embodiment except as is described below. The tablet computer 12 and the camera 14 are thus operative as described above to perform recognition of facial expressions of the user when the user wishes to control the home automation system. In this embodiment the control functions are operative to provide for different forms of control of the home automation system, such as in respect of turning lights on or off or controlling heating. A match between a recognised facial expression and one of the sets of predetermined facial expression data causes the mapped one of the control functions to be invoked whereby the second computing apparatus 18 and hence the home automation system is controlled in the desired fashion.

1. A control arrangement comprising:
computer apparatus storing a control function which controls computer software in dependence on control data received by the control function from a manually or voice operated user interface; and
a camera providing image data to the computer apparatus in dependence on at least one image acquired by the camera,
the computer apparatus: recognising a facial expression in image data received from the camera when the camera acquires an image of a face; and operating the control function in dependence on the recognised facial expression, whereby the computer software is controlled by the facial expression instead of by operation of the manually or voice operated user interface.

2. The control arrangement according to claim 1, in which the computer apparatus: stores plural control functions, the plural control functions controlling computer software in respective plural different ways in dependence on respective control data received by the control function from a manually or voice operated user interface; recognises each of plural facial expressions in image data received from the camera when the camera acquires images of a face; maps each of the plural facial expressions to a respective one of the plural control functions; and operates each of the plural control functions in dependence on a mapped one of the plural facial expressions.

3. The control arrangement according to claim 1, in which the computer apparatus recognises a part of an image of a face and determines movement of the part of the image.

4. The control arrangement according to claim 3, in which the computer apparatus determines movement of the part of the image relative to itself.

5. The control arrangement according to claim 3, in which the computer apparatus recognises a further part of the image of the face and determines movement of the part of the image relative to a further part of the image.

6. The control arrangement according to claim 1, in which the computer apparatus recognises in the image at least one of position and movement of the face itself.

7. The control arrangement according to claim 1, in which the control function is operated in dependence on both of: recognition of the facial expression; and determining in the image an orientation of a head comprising the face having the recognised facial expression.

8. The control arrangement according to claim 1, in which the computer apparatus determines a direction of eye gaze in the image of the face.

9. The control arrangement according to claim 8, in which the eye gaze direction is determined relative to part of a graphical user interface on a display of the computer apparatus.

10. The control arrangement according to claim 8, in which the computer apparatus recognises a change in the facial expression while the eye gaze is held in the determined direction.

11. The control arrangement according to claim 1, in which the computer apparatus places a call to the control function to thereby invoke the control function in dependence on recognition of the facial expression.

12. The control arrangement according to claim 1, in which the computer software is one of application software and system software.

13. The control arrangement according to claim 12 and where the computer software is application software, in which the control function controls at least one of:
starting or stopping the application software; saving or uploading data relating to the application software; and configuring the application software in respect of operation of the application software.

14. The control arrangement according to claim 12 and where the computer software is system software, in which the control function controls at least one of: powering down the computer apparatus; installing or deleting application software; loading and executing application software; configuring a user interface such as a display; and controlling a peripheral device.

15. The control arrangement according to claim 1 comprising first and second computer apparatus, in which the first computer apparatus recognises the facial expression in the image data, the control function is stored in one of the first and second computer apparatus, the computer software runs on the second computer apparatus, and the second computer apparatus controls the control function in dependence on recognition of the facial expression by the first computer apparatus.

16. The control arrangement according to claim 15, in which the first and second computer apparatus are remote from each other, the second computer apparatus controlling the control function in dependence on communication of data over a communication channel between the first and second computer apparatus.

17. The control arrangement according to claim 15, in which the first computer apparatus is personal computing apparatus and the second computer apparatus is one of: a home entertainment system; a home automation system; a game system; and a sound producing electronic device.

18. The control arrangement according to claim 1 in which the control function controls a musical or audio device.

19. The control arrangement according to claim 1 in which the control function is a MIDI message, the computer software being operative in dependence on the MIDI message.

20. A control process comprising:
storing a control function in computer apparatus, the control function controlling computer software in dependence on control data received by the control function from a manually or voice operated user interface;
providing image data to the computer apparatus from a camera in dependence on at least one image acquired by the camera;
recognising a facial expression in image data received from the camera when the camera acquires an image of a face; and
operating the control function in dependence on the recognised facial expression, whereby the computer software is controlled by the facial expression instead of by operation of the manually or voice operated user interface.
